(19) United States
(12) Patent Application Publication
(10) Pub. No.: US 2004/0140010 A1
(43) Pub. Date: Jul. 22, 2004

(54) Cloth tube, jointed cloth tube, and tube fabrication method

(76) Inventors: Robert Hasslberger, Ruhpolding (DE); Michael Wagner, Grabenstatt (DE)

Correspondence Address: LERNER AND GREENBERG, P.A., Post Office Box 2480, Hollywood, FL, 33022-2480, US

(21) Appl. No.: 10/755,043

(22) Filed: Jan. 9, 2004

Related U.S. Application Data
(63) Continuation of application No. PCT/EP02/06850, filed on Jun. 20, 2002.

(30) Foreign Application Priority Data
Jul. 9, 2001 (DE) 101 33 234.3

(51) Int. Cl. F16L 11/00

(52) U.S. Cl. 138/123; 138/109; 138/120

(57) ABSTRACT

A fabric tube made from highly resistant and thermostable threads has at least one tube end that is inverted inwards, the inverted tube section resting substantially parallel on the inner wall of the fabric tube. Two of such tubes can be connected to each other for forming a jointed tube. A method for producing the jointed tube uses a transition piece for connecting the individual parts to each other.

### CROSS-REFERENCE TO RELATED APPLICATION

This application is a continuation of copending International Application No. PCT/EP02/06850, filed Jun. 20, 2002, which designated the United States and was not published in English.

### BACKGROUND OF THE INVENTION

Field of the Invention

The present invention relates to a cloth tube, hose or tubing formed of high-stability and heat-resistant threads and a method for its fabrication.

The ends of cloth tubes, hoses or tubing (hereinafter referred to only as tube) tend to fray given movement and stressing of the tube if countermeasures are not taken. Possible countermeasures for sealing the tube ends include soaking them in plastic, overwrapping them and sewing them shut, or sewing a vignette or cuff around them. A tube piece which has been sealed, for instance by silicon impregnation, can also be drawn over the end of the tube. Another known technique is to clamp the tube end with a large-surface clamp or to cotter it with several thin metal clamps.

A common feature of all these techniques is that the fastening of the tube ends is relatively expensive. An additional disadvantage is that the fastenings are partly non-heat-resistant, which is indispensable for some instances of application. Furthermore, the curings are in part visually unsatisfactory. Another disadvantage is that this kind of tube end that is pushed onto an extension piece takes away part of its flexibility.

### SUMMARY OF THE INVENTION

It is accordingly an object of the invention to provide a cloth tube, jointed cloth tube, and tube fabrication method which overcome the above-mentioned disadvantages of the prior art devices and methods of this general type, which provides a flexible and simple tube termination for a cloth tube.

With the foregoing and other objects in view there is provided, in accordance with the invention, a cloth tube. The cloth tube contains a tube body having an inner wall and formed of high-strength heat-resistant threads. The tube body further has at least one end folded inwardly resulting in an inwardly folded portion. The inwardly folded portion lies adjacent the inner wall of the tube body in a substantially parallel fashion.

In the cloth (fabric) tube formed of the high-stability and heat-resistant threads, at least one end of the tube is folded back inside, which folded portion adjoins the inner wall of the cloth tube in a substantially parallel fashion. The advantage of the inventive cloth tube is that the end, which otherwise tends to fray, acquires a durable and shapely termination, which is also sufficiently flexible. No further components or measures are needed in order to achieve the fold.

According to an embodiment of the invention, the cloth tube is a seamless woven tube, which has the advantage that there is no longitudinal edge in the tube that could represent a mechanical weakness. In addition, the tube would be less flexible at a longitudinal seam.

Another inventive embodiment provides that the threads of the cloth tube include fiberglass. Such a fiberglass tube is particularly heat-resistant yet flexible and can therefore be used for particularly exposed locations. For example, it makes a suitable cable sheathe in stove doors or such like.

According to an alternative embodiment of the invention, the threads of the cloth tube are formed of carbon fibers, which give the tube greater stability compared to a fiberglass fabric.

In another embodiment of the invention, the folded tube portion at least at one end of the tube is at least half as long as the tube diameter, with the advantage that the tube end is reliably protected against fraying even when repeated bending and pulling stress is applied. The tube end also remains sufficiently flexible.

According to another inventive embodiment, the folded tube portion is sewn and/or glued and/or clamped to the end of the tube. The advantage of this embodiment is that the end of the tube is not prone to fraying even under repeated alternating stress.

In an inventive joining of two cloth tubes formed of the high-strength heat-resistant threads according to one of the above embodiments, their abutting ends are respectively folded inward, and the ends are pushed over a transition piece. The advantage of the inventive joining is that the tube joint is simple and inexpensive to make and exhibits characteristics barely worse than a seamless tube. The space requirement of such a tube joint is minimal, because the inserted transition piece has approximately the same diameter as the cloth tubes that are folded in and pushed over it.

According to an inventive embodiment, the transition piece is a tube portion formed of a cloth tube or cloth tape, the advantage of which is that the desired characteristics of the cloth tube also pertain to the transition piece, for instance the heat resistance or the high mechanical strength.

According to an inventive embodiment, the two tube ends are glued and/or sewn and/or clamped to the transition piece. The advantage is that the stability is further enhanced compared to the above-described embodiments, because the ends of the tubes are better protected against fraying.

According to an alternative joining of the two cloth tubes formed of the high-strength heat-resistant threads, the end of the first cloth tube is folded in, and an open end of the second tube is inserted into the folded end of the first tube. The advantage of the inventive joint is that the two cloth tubes can be joined particularly easily, because the open end can fray and is still surrounded by the folded end. That way, the tube joint is reliably protected against fraying of one of the tube ends. The inventive joint is characterized by a very small space requirement, because the tube ends, when they are pushed over one another, have a diameter barely larger than that of the cloth tube itself.

According to an embodiment of the inventive joint, the tube ends are additionally glued and/or sewn and/or clamped to one another, which can further enhance stability without making the joint substantially more voluminous or more expensive.

According to a method for producing a cloth tube from high-strength heat-resistant threads, the cloth tube is seamless, and at least one end of the tube is folded back inward in such a way that the folded portion adjoins the inner wall of the cloth tube in a substantially parallel fashion. With this method, seamless high-strength heat-resistant cloth tubes can be produced, where the tube ends are reliably protected against fraying of their threads. Another advantage of the method is that it is very simple and cost-effective. The folded tube end can subsequently be sewn and/or glued and/or clamped to the cloth tube, which can further enhance the strength of the tube end.

Other features which are considered as characteristic for the invention are set forth in the appended claims.

Although the invention is illustrated and described herein as embodied in a cloth tube, jointed cloth tube, and tube fabrication method, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, sectional view of an end of a cloth tube that is folded inside according to the invention;

FIG. 2 is a diagrammatic, sectional view of two tube ends which are joined by a butt joint using a transition piece; and

FIG. 3 is a diagrammatic, sectional view of an alternative joining of two tube ends.

### DESCRIPTION OF THE PREFERRED EMBODIMENTS

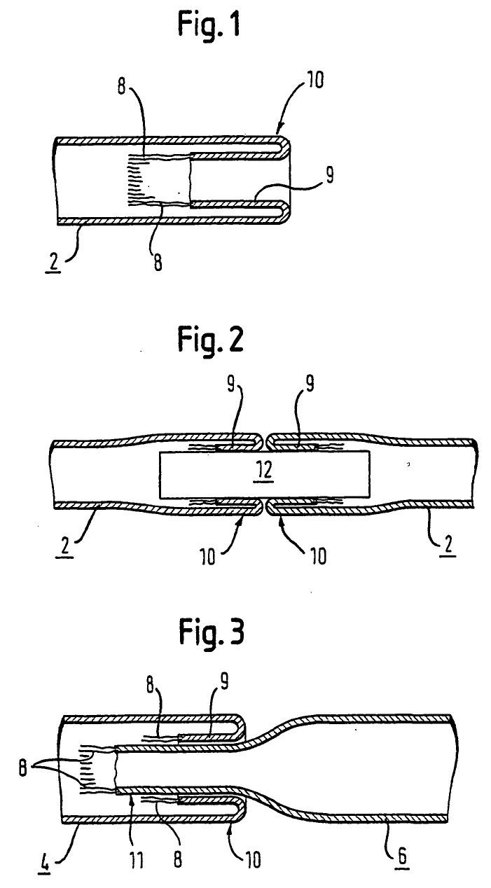

Referring now to the figures of the drawing in detail and first, particularly, to FIG. 1 thereof, there is shown a tube end 10 of a cloth (fabric) tube, hose or tubing 2 which is folded in accordance with the invention. This guarantees that open fibers 8 at the tube end 10 cannot fray out and impair the visual impression and, given long-term stress, lead to weakening of the tube end 10. A folded tube portion 9 is advantageously at least half as long as the diameter of the cloth tube 2. That way, no fibers 8 can escape at the tube end 10 and lead to additional fraying of the tube end 10. The folded portion 9 can be additionally glued, sewn, or clamped to the tube end 10, which increases stability. Protection against fraying can also be achieved by these measures.

FIG. 2 represents two joined ends 10 of two cloth tubes 2, which are joined by a butt joint via a connecting piece or transition piece 12. The transition piece 12 can likewise be formed of a piece of cloth tube or fabric tape. Other variants are also possible, bearing in mind that the desired characteristics of the cloth tube 2 with respect to strength and thermal resistance can only be guaranteed in the joint when the transition piece 12 exhibits characteristics at least equivalent to that of the cloth tube. The folded tube portions 9 of the tube ends 10 of the two cloth tubes 2 are pushed over the transition piece 12 so that the ends 10 abut. The strength of the joint can be additionally increased by gluing, sewing, or clamping. The space requirement of the joint location is only minimally larger than that of a seamless cloth tube 2. The joint location can also satisfy all visual requirements.

FIG. 3 represents a joint of two ends 10, 11 of cloth tubes 4, 6, one end of which is folded in, and the other end of which is an open end that is inserted into the folded end. The end 10 of the first cloth tube 4 is folded in as described above. The open end 11 of the second cloth tube 6 that is inserted into the folded end 10 can fray into fibers 8 more easily, but in this case no harm is done, because it is covered and protected by the end 10 of the first tube 4 that is pushed over it. The joint also can be made easily and inexpensively and can be given greater stability by sewing, gluing, or clamping.

It is clear to the ordinary person skilled in the art that the invention is not limited to the exemplifying embodiment represented here; rather, a number of variants and modifications are embraced.

We claim:

1. A cloth tube, comprising:
a tube body having an inner wall and formed of high-strength heat-resistant threads, said tube body further having at least one end folded inwardly resulting in an inwardly folded portion, said inwardly folded portion lying adjacent said inner wall of said tube body in a substantially parallel fashion.

2. The cloth tube according to claim 1, wherein said tube body is a seamless tube.

3. The cloth tube according to claim 1, wherein said threads contain fiberglass.

4. The cloth tube according to claim 1, wherein said threads contain carbon fibers.

5. The cloth tube according to claim 1, wherein:
said tube body has a given diameter; and
said inwardly folded tube portion is at least half as long as said given diameter of said tube body.

6. The cloth tube according to claim 1, wherein said inwardly folded portion is one of sewn, glued and clamped to at least said end of said tube body.

7. A jointed tube, comprising:
a transition piece;
a first tube body having a first inner wall and formed of high-strength heat-resistant threads, said first tube body further having at least one first end folded inwardly resulting in an first inwardly folded portion, said first inwardly folded portion lying adjacent said first inner wall of said first tube body in a substantially parallel fashion and pushed over a part of said transition piece; and
a second tube body having a second inner wall and formed of said high-strength heat-resistant threads, said second tube body further having at least one second end folded inwardly resulting in a second inwardly folded portion, said second inwardly folded portion lying adjacent said second inner wall of said second tube body in a substantially parallel fashion and pushed over another part of said transition piece.

8. The jointed tube according to claim 7, wherein said transition piece is a portion of one of said first and second tube body.

9. The jointed tube according to claim 7, wherein said first and second ends are at least one of glued, sewn and clamped to said transition piece.

10. The jointed tube according to claim 7, wherein said transition piece is a fabric band portion.

11. A jointed tube, comprising:
a first tube body formed of high-strength heat-resistant threads and having a first open end; and
a second tube body formed of said high-strength heat-resistant threads and having a second folded end being folded in, and said first open end being disposed in said second folded end.

12. The jointed tube according to claim 11, wherein said second folded end is folded inwardly resulting in a second inwardly folded portion, said second inwardly folded portion lying adjacent an inner wall of said second tube body in a substantially parallel fashion.

13. The jointed tube according to claim 11, wherein said first open end and said second folded end are at least one of glued, sewn and clamped to each other.

14. A method for producing a seamless cloth tube, which comprises the steps of:
forming a tube body from high-strength and heat-resistant threads and having an inner wall; and
folding at least one end of the tube body inwardly resulting in an inwardly folded portion adjoining the inner wall of the tube body in a substantially parallel fashion.

15. The method according to claim 14, which further comprises:
securing the inwardly folded portion to the tube body by at least one of sewing, gluing, and clamping.
